(19) United States
(12) Patent Application Publication
(10) Pub. No.: US 2026/0197067 A1
(43) Pub. Date: Jul. 9, 2026

(54) ENHANCED UPLINK FREQUENCY DIVISION MULTIPLEXING SCHEDULING UTILIZING HIGH RESOLUTION BEAM BOOK

(71) Applicant: SAMSUNG ELECTRONICS CO., LTD., Suwon-si (KR)

(72) Inventors: Mohammed Saquib Noorulhuda KHAN, Bangalore (IN); Jianhua MO, Mountain View, CA (US); Younghan NAM, Mountain View, CA (US); Surabhi Garudangiri DAYANANDA, Bangalore (IN); Sundo KIM, Suwon-si (KR); Ahmad Mohammad Abdel-Karim ALAMMOURI, Mountain View, CA (US)

(21) Appl. No.: 19/442,835

(22) Filed: Jan. 7, 2026

(30) Foreign Application Priority Data
Jan. 7, 2025 (IN) 202541001530
Dec. 12, 2025 (IN) 202541001530

(51) Int. Cl. H04B 7/06; H04W 72/1263

(52) U.S. Cl. CPC H04B 7/06952; H04W 72/1263

(57) ABSTRACT

The present disclosure relates to a communication method and system for converging a 5th-Generation (5G) communication system or a 6th-Generation (6G) communication system for supporting higher data rates beyond a 4th-Generation (4G) system. The present disclosure relates to a methods and network apparatus to implementation of enhanced uplink frequency division multiplexing scheduling with high resolution beam book. The proposed solution introduces three novel scheduling techniques adjacent beam scheduling that leverages spatial overlap in High-Resolution Beam Books (HRBB) to aggregate UEs from neighboring beams, hybrid beam book scheduling, combining HRBB and Normal-Resolution Beam Book (NRBB) beams in fixed configurations and adaptive beam switching dynamically selecting HRBB or NRBB based on real-time bandwidth demands. By using this novel scheduling techniques system-level simulations in urban macrocellular deployments demonstrate that these strategies improve uplink FDM opportunities by up to 23.6% and enhance UE uplink throughput by 5-77% across diverse inter-site distance scenarios. The proposed methods effectively balance beamforming precision and resource utilization, offering scalable solutions for 5G and future mm Wave networks.

### CROSS-REFERENCE TO RELATED APPLICATIONS

This application is based on and claims priority under 35 U.S.C. § 119 (a) of an Indian Provisional patent application No. 202541001530, filed on Jan. 7, 2025, in the Indian Intellectual Property Office, and of an Indian Non-Provisional patent application No. 202541001530, filed on Dec. 12, 2025, in the Indian Intellectual Property Office, the disclosure of each of which is incorporated by reference herein in its entirety.

### BACKGROUND

### 1. Field

This disclosure relates to the field of wireless communication systems. More particularly, it addresses methods and network apparatus for enhanced scheduling of uplink frequency division multiplexing (FDM) by utilizing a high-resolution beam book.

### 2. Description of Related Art

Considering the development of mobile communication from generation to generation, the technologies have been developed mainly for services targeting humans, such as voice calls, multimedia services, and data services. Following the commercialization of 5G (5th-generation) communication systems, it is expected that the number of connected devices will exponentially grow. Increasingly, these will be connected to communication networks. Examples of connected things may include vehicles, robots, drones, home appliances, displays, smart sensors connected to various infrastructures, construction machines, and factory equipment. Mobile devices are expected to evolve in various form-factors, such as augmented reality glasses, virtual reality headsets, and hologram devices. In order to provide various services by connecting hundreds of billions of devices and things in the 6G (6th-generation) era, there have been ongoing efforts to develop improved 6G communication systems. For these reasons, 6G communication systems are referred to as Beyond-5G systems.

6G communication systems, which are expected to be commercialized around 2030, will have a peak data rate of tera (1,000 giga)-level bps and a radio latency less than 100 μsec, and thus will be 50 times as fast as 5G communication systems and have the 1/10 radio latency thereof.

In order to accomplish such a high data rate and an ultra-low latency, it has been considered to implement 6G communication systems in a terahertz band (for example, 95 GHz to 3 THz bands). It is expected that, due to severer path loss and atmospheric absorption in the terahertz bands than those in mmWave bands introduced in 5G, technologies capable of securing the signal transmission distance (that is, coverage) will become more crucial. It is necessary to develop, as major technologies for securing the coverage, multiantenna transmission technologies including radio frequency (RF) elements, antennas, novel waveforms having a better coverage than OFDM, beamforming and massive MIMO, full dimensional MIMO (FD-MIMO), array antennas, and large-scale antennas. In addition, there has been ongoing discussion on new technologies for improving the coverage of terahertz-band signals, such as metamaterial-based lenses and antennas, orbital angular momentum (OAM), and reconfigurable intelligent surface (RIS).

Moreover, in order to improve the spectral efficiency and the overall network performances, the following technologies have been developed for 6G communication systems: a full-duplex technology for enabling an uplink (UE transmission) and a downlink (node B transmission) to simultaneously use the same frequency resource at the same time; a network technology for utilizing satellites, high-altitude platform stations (HAPS), and the like in an integrated manner; an improved network structure for supporting mobile nodes B and the like and enabling network operation optimization and automation and the like; an use of AI in wireless communication for improvement of overall network operation by considering AI from the initial phase of developing technologies for 6G and internalizing end-to-end AI support functions; and a next-generation distributed computing technology for overcoming the limit of UE computing ability through reachable super-high-performance communication and computing resources (MEC, clouds, and the like) over the network.

It is expected that such research and development of 6G communication systems will bring the next hyper-connected experience to every corner of life. Particularly, it is expected that services such as truly immersive XR, high-fidelity mobile hologram, and digital replica could be provided through 6G communication systems.

Millimeter-wave (mmWave) frequencies (24-100 GHz) are integral to 5G New Radio (NR) and beyond, offering multi gigabit throughput through wide bandwidths in frequency range 2 (FR2). However, mmWave signals suffer from high propagation losses, atmospheric absorption, and blockage susceptibility, necessitating robust beamforming for reliable communication. Beamforming via phased arrays mitigates mmWave issues by focusing energy directionally, with performance heavily dependent on the resolution of the beam codebook or “beam book” defining available beam patterns at the base station (BS).

In mmWave systems, a normal-resolution beam book (NRBB) offers a limited set of beams, which may suffice for cell-center User Equipment's (UEs) but often fall short for cell-edge UEs due to higher path loss and suboptimal beam alignment. This leads to weaker signals, increased interference, and reduced throughput. To address these challenges, a high-resolution beam book (HRBB) introduces a denser set of finely quantized beams, allowing more precise alignment between the BS and UEs. This improves beamforming gain, reduces interference, enhances downlink throughput, and significantly improving link reliability, particularly for cell-edge UEs. However, while the HRBB improves signal quality, it also disperses UEs across more narrowly focused beams. This reduces the number of UEs within each beam, limiting opportunities for FDM in the uplink (UL). The FDM is vital in UL transmission as it enables multiple UEs to transmit simultaneously over separate frequency resources, maximizing spectral efficiency and overall system throughput. When the FDM is underutilized, as often happens with the HRBB, the network experiences increased scheduling latency, underutilized bandwidth, and reduced UL performance. Thus, although the HRBB offers superior directional gain, it introduces a trade-off between beam precision and multiplexing capacity, necessitating scheduling strategies that restore FDM efficiency while retaining the benefits of high-resolution beamforming.

Existing mmWave scheduling solutions address beam management inefficiencies but struggle with resolving the HRBB specific FDM constraints. Hierarchical codebooks have been widely adopted to reduce latency during beam training by iteratively refining beam widths. However, this technique can limit spectral efficiency due to fixed multi-resolution partitioning. Efforts to optimize these codebooks for multi-UE scenarios have enhanced beam training speed but faced challenges adapting to dynamic UE distributions.

The trade-off between angular resolution and scheduling efficiency remains a key consideration. The HRBB improves beam forming accuracy but may fragment the UEs across overlapping beams, complicating multi-UE scheduling. Meanwhile, heuristic schedulers using coarse codebooks increase frequency reuse, although this comes at the cost of alignment inaccuracies. Machine learning (ML) methods for beam tracking have optimized performance for individual UEs, but they tend to overlook the impact on the FDM efficiency.

Emerging technologies such as reconfigurable intelligent surfaces (RIS) offer promising solutions for enhancing coverage, but integrating RIS with dense codebooks poses challenges, especially in managing dynamic UE traffic. Despite advances in codebook design and scheduling, a core limitation remains: the finer angular quantization of high-resolution codebooks reduces the UE density per beam, intrinsically limiting the FDM efficiency. Existing scheduling approaches further exacerbate this problem by bundling UEs to a single beam, while multi beam strategies focus primarily on downlink throughput or require unrealistic UL traffic clustering.

Thus, it is desired to address the above-mentioned disadvantages or other shortcomings or at least provide a useful alternative.

### SUMMARY

The principal object of the present disclosure herein is to provide a method and implementation of enhanced UL FDM scheduling with a HRBB.

Another object of the present disclosure herein is to provide adjacent-beam scheduling where the adjacent beam scheduling controller schedules the users in the adjacent beams from the primary beam.

Another object of the present disclosure herein is to provide a hybrid beam book where the hybrid beam book controller combines the HRBB for cell-edge and the NRBB for cell-center.

Another object of the present disclosure herein is to provide adaptive switching where the adaptive beam-switching controller dynamically selects the HRBB or the NRBB based on a real-time bandwidth demand.

In an aspect, the objects are achieved by providing a method for scheduling UEs in a wireless communication system. The method includes performing, by a network apparatus, beam sweeping using an HRBB, where the beam sweeping determines a beam for each UE of a plurality of UEs, and computing, by the network apparatus, a scheduling metric for each UE of the plurality of UEs. Further, the method also includes: selecting, by the network apparatus, a primary UE based on the highest scheduling metric among the plurality of UEs, where the beam corresponding to the primary UE is identified as a primary beam; and allocating, by the network apparatus, communication resources to the primary UE. Furthermore, the method further includes: determining, by the network apparatus, whether residual bandwidth remains after allocation of the communication resources to the primary UE; and scheduling, by the network apparatus, additional UEs using the residual bandwidth, where the additional UEs include UEs located within the primary beam and UEs located in beams adjacent to the primary beam, and where the scheduling of the additional UEs utilizes a spatial overlap to increase spectrum utilization.

In an aspect, the objects are achieved by providing a method for scheduling UEs in a wireless communication system. The method includes: configuring, by a network apparatus, a beam book comprising a plurality of beam types for coverage of different cell regions including HRBBs for cell-edge coverage and NRBBs for cell-center coverage, where the HRBBs are used to serve the cell-edge users and the NRBBs are used to serve the cell-center users and the beam book includes a plurality of beam entries; performing, by the network apparatus, beam sweeping within the beam book to obtain beam measurements for each mapped UE; and processing, by the network apparatus, the beam measurements to produce scheduling metrics for each UE, where the scheduling metrics include at least one of channel quality indicator, buffer occupancy level, UE priority, UE's current data rate, historical average throughput, or spatial overlap coefficient. Furthermore, the method further includes: selecting, by the network apparatus, a primary UE based on the scheduling metrics, the primary beam associated with the primary UE, scheduling the primary UE on an associated beam where UEs mapped to the HRBBs are prioritized over UEs mapped to the NRBBs when selecting the primary UE; allocating, by the network apparatus, residual bandwidth to additional UEs based on the scheduling metrics where allocation includes scheduling secondary UEs in the primary beam and UEs mapped to the NRBBs based on the scheduling metrics to increase multiplexing efficiency; and instantiating, by the network apparatus, the scheduling decision by provisioning resource grants and control signaling to the scheduled UEs where the beam book is predefined or dynamically reconfigurable to balance cell-edge coverage and cell-center multiplexing.

In an aspect, the objects are achieved by providing a method for scheduling UEs in a wireless communication system. The method includes: initializing, by a network apparatus, a dual-beam book comprising HRBBs for precise directional transmission and NRBBs for broader coverage; and determining, by the network apparatus, an optimal beam for each UE by performing beam sweeping using the HRBBs based on at least one of signal quality or geographical position. Further, the method also includes: identifying, by the network apparatus, a primary UE having the highest scheduling metric and one or more secondary UEs having next-highest scheduling metrics within the same HRBB and adding the primary UE and the one or more secondary UEs to a scheduled-UE list′ and determining, by the network apparatus, bandwidth consumed by the primary UE and the one or more secondary UEs and comparing the consumed bandwidth with the total available bandwidth. Furthermore, the method further includes: retaining, by the network apparatus, the HRBB for the primary UE and the one or more secondary UEs when the consumed bandwidth equals the total available bandwidth where the retention maintains spectral efficiency; switching, by the network apparatus, to a corresponding NRBB for the same angular region to utilize residual bandwidth and to schedule additional UEs using broader coverage when the consumed bandwidth is less than the total available bandwidth; computing, by the network apparatus, scheduling metrics for UEs mapped to the NRBB; scheduling, by the network apparatus, UEs in the NRBB having highest scheduling metrics until the bandwidth is fully utilized; and implementing, by the network apparatus, a scheduling outcome comprising UEs scheduled from both HRBBs and NRBBs.

In an aspect, the objects are achieved by providing a network apparatus for scheduling UEs in a wireless communication system. The network apparatus includes a processor, a memory, and an adjacent beam scheduling controller connected to the memory and the processor. The adjacent beam scheduling controller performs beam sweeping using an HRBB where the beam sweeping determines a beam for each UE of a plurality of UEs and computes a scheduling metric for each UE of the plurality of UEs. The adjacent beam scheduling controller further selects a primary UE based on the highest scheduling metric among the plurality of UEs where the beam corresponding to the primary UE is identified as a primary beam and allocates communication resources to the primary UE. The adjacent beam scheduling controller furthermore determines whether residual bandwidth remains after allocation of the communication resources to the primary UE and schedules one or more additional UEs using the residual bandwidth, the one or more additional UEs comprise secondary UEs located within the primary beam and UEs located in adjacent beams of the primary beam and where the scheduling of the secondary UEs and the UEs located in the adjacent beams utilizes spatial overlap to increase spectrum utilization.

In an aspect, the objects are achieved by providing a network apparatus for scheduling UEs in a wireless communication system. The network apparatus includes a processor, a memory, and a hybrid beam book controller connected to the memory and the processor. The hybrid beam book controller configures a beam book including a plurality of beam types for coverage of different cell regions including HRBBs for cell-edge coverage and NRBBs for cell-center coverage where the HRBBs are used to serve the cell-edge users and the NRBBs are used to serve the cell-center users and the beam book includes a plurality of beam entries, performs beam sweeping within the beam book to obtain beam measurements for each mapped UE, processes the beam measurements to produce scheduling metrics for each UE where the scheduling metrics include at least one of a channel quality indicator, UE priority, UE's current data rate, historical average throughput, buffer occupancy level, or spatial overlap coefficient, and selects a primary UE based on the scheduling metrics, the primary beam associated with the primary UE, and scheduling the primary UE on an associated beam where UEs mapped to the HRBBs are prioritized over UEs mapped to the NRBBs when selecting the primary UE. The hybrid beam book controller furthermore allocates residual bandwidth to one or more additional UEs based on the scheduling metrics where allocation includes scheduling secondary UEs in the primary beam and UEs mapped to the NRBBs based on the scheduling metrics to increase multiplexing efficiency and instantiates the scheduling decision by provisioning resource grants and control signaling to the scheduled UEs where the beam book is predefined or dynamically reconfigurable to balance cell-edge coverage and cell-center multiplexing.

In an aspect, the objects are achieved by providing a network apparatus for scheduling UEs in a wireless communication system. The network apparatus includes a processor, a memory, and an adaptive beam-switching controller connected to the memory and the processor. The adaptive beam-switching controller initializes a dual-beam book comprising HRBBs for precise directional transmission and NRBBs for broader coverage, determines an optimal beam for each UE by performing beam sweeping using the HRBBs based on at least one of signal quality and geographical position, and identifies a primary UE having the highest scheduling metric and one or more secondary UEs having next-highest scheduling metrics within the same HRBB and adding the primary UE and the one or more secondary UEs to a scheduled-UE list. The adaptive beam-switching controller further determines bandwidth consumed by the primary UE and the one or more secondary UEs and comparing the consumed bandwidth with the total available bandwidth, retains the HRBB for the primary UE and the one or more secondary UEs when the consumed bandwidth equals the total available bandwidth where the retention maintains spectral efficiency, and switches to a corresponding NRBB for the same angular region to utilize residual bandwidth and to schedule additional UEs using broader coverage when the consumed bandwidth is less than the total available bandwidth. The adaptive beam-switching controller furthermore computes scheduling metrics for UEs mapped to the NRBB, schedules UEs in the NRBB having highest scheduling metrics until the bandwidth is fully utilized, and implements a scheduling outcome comprising UEs scheduled from both HRBBs and NRBBs.

Before undertaking the DETAILED DESCRIPTION below, it may be advantageous to set forth definitions of certain words and phrases used throughout this patent document: the terms “include” and “comprise,” as well as derivatives thereof, mean inclusion without limitation; the term “or,” is inclusive, meaning and/or; the phrases “associated with” and “associated therewith,” as well as derivatives thereof, may mean to include, be included within, interconnect with, contain, be contained within, connect to or with, couple to or with, be communicable with, cooperate with, interleave, juxtapose, be proximate to, be bound to or with, have, have a property of, or the like; and the term “controller” means any device, system or part thereof that controls at least one operation, such a device may be implemented in hardware, firmware or software, or some combination of at least two of the same. It should be noted that the functionality associated with any particular controller may be centralized or distributed, whether locally or remotely.

Moreover, various functions described below can be implemented or supported by one or more computer programs, each of which is formed from computer readable program code and embodied in a computer readable medium. The terms “application” and “program” refer to one or more computer programs, software components, sets of instructions, procedures, functions, objects, classes, instances, related data, or a portion thereof adapted for implementation in a suitable computer readable program code. The phrase “computer readable program code” includes any type of computer code, including source code, object code, and executable code. The phrase “computer readable medium” includes any type of medium capable of being accessed by a computer, such as read only memory (ROM), random access memory (RAM), a hard disk drive, a compact disc (CD), a digital video disc (DVD), or any other type of memory. A “non-transitory” computer readable medium excludes wired, wireless, optical, or other communication links that transport transitory electrical or other signals. A non-transitory computer readable medium includes media where data can be permanently stored and media where data can be stored and later overwritten, such as a rewritable optical disc or an erasable memory device.

Definitions for certain words and phrases are provided throughout this patent document, those of ordinary skill in the art should understand that in many, if not most instances, such definitions apply to prior, as well as future uses of such defined words and phrases.

### BRIEF DESCRIPTION OF THE DRAWINGS

The example embodiments of the present disclosure are illustrated in the accompanying drawings, throughout which like reference letters indicate corresponding parts in the various figures. The embodiments herein will be better understood from the following description with reference to the drawings, in which:

FIG. 1 illustrates a schematic diagram depicting an example scheduling approach;

FIG. 2 illustrates a block diagram of a network apparatus according to example embodiments of the present disclosure;

FIG. 3 illustrates a flow chart for an adjacent beam UEs scheduling method according to example embodiments of the present disclosure;

FIG. 4 illustrates a flow chart for a hybrid beam book scheduling method according to example embodiments of the present disclosure;

FIG. 5 illustrates a flow chart for an adaptive beam-switching method according to example embodiments of the present disclosure;

FIG. 6 illustrates diagrams depicting an adjacent beam scheduling method according to example embodiments of the present disclosure;

FIG. 7 illustrates a diagram depicting a hybrid beam book scheduling method according to example embodiments of the present disclosure;

FIG. 8A illustrates a diagram depicting an example 1040-beam hybrid beam book according to example embodiments of the present disclosure; and

FIG. 8B illustrates a diagram depicting an example 800-beam hybrid beam book according to example embodiments of the present disclosure.

### DETAILED DESCRIPTION

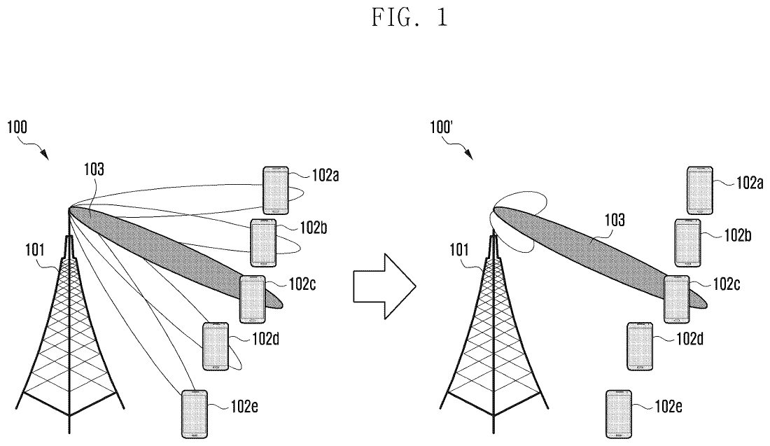

FIGS. 1 through 8B, discussed below, and the various embodiments used to describe the principles of the present disclosure in this patent document are by way of illustration only and should not be construed in any way to limit the scope of the disclosure. Those skilled in the art will understand that the principles of the present disclosure may be implemented in any suitably arranged system or device.

The embodiments herein and the various features and advantageous details thereof are explained more fully with reference to the non-limiting embodiments that are illustrated in the accompanying drawings and detailed in the following description. Descriptions of well-known components and processing techniques are omitted so as to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or, unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is existing in the field, embodiments can be described and illustrated in terms of blocks which carry out a described function or functions. These blocks, which can be referred to herein as managers, units, modules, hardware components or the like, are physically implemented by analog and/or digital circuits such as logic gates, integrated circuits, microprocessors, microcontrollers, memory circuits, passive electronic components, active electronic components, optical components, hardwired circuits and the like, and can optionally be driven by firmware and software. The circuits may, for example, be embodied in one or more semiconductor chips, or on substrate supports such as printed circuit boards and the like. The circuits constituting a block can be implemented by dedicated hardware, or by a processor (e.g., one or more programmed microprocessors and associated circuitry), or by a combination of dedicated hardware to perform some functions of the block and a processor to perform other functions of the block. Each block of the embodiments can be physically separated into two or more interacting and discrete blocks without departing from the scope of the disclosure. Likewise, the blocks of the embodiments can be physically combined into more complex blocks without departing from the scope of the disclosure.

The accompanying drawings facilitate understanding of various technical features. The embodiments are not limited by these drawings; the disclosure includes any alterations, equivalents, and substitutes beyond those depicted. Terms like “first,” “second,” etc., are used for distinction and should not limit the elements described.

Millimeter-wave (mmWave) communications in 5th Generation (5G) networks leverage high-frequency bands to achieve ultra-fast data rates and low latency. However, they face a critical trade-off between beamforming precision and uplink Frequency Division Multiplexing (FDM) efficiency. This trade-off arises because mmWave communications rely on beamforming to overcome the high path loss and penetration limitations of these frequencies. In mmWave communication, beamforming focuses the signal energy into narrow beams, enhancing signal strength and reducing interference.

Throughout the specification, the definitions of the various terms used in the embodiments are as follows:
Beam Coverage: A beam, whether an HRBB or a NRBB, covers a specific geographic area. This area can include multiple UEs within its range.
Frequency Division: Within the coverage area of a single beam, different frequency bands are allocated to different users. This is where the FDM comes into play. Each user is assigned a unique frequency band within the beam's spectrum, allowing them to transmit data simultaneously without interference.
HRBB: An HRBB is a beamforming codebook that includes a large number of finely quantized beam directions, typically much higher than in an NRBB. Importantly, the beam width of the HRBB beams remains the same as the beam width of the NRBB beams. The difference lies in the granularity the number of beams covering the angular space. The HRBB enables more accurate alignment between the BS and the UEs. This improves beamforming gain, enhances Signal-to-Noise Ratio (SNR), and reduces interference leakage, resulting in stronger and more reliable links. The precise steering capability of the HRBB is particularly beneficial for cell-edge users in mmWave and FR2 bands, where path loss is severe. By providing finer granularity in beam selection, the HRBB enhances the ability to align beams accurately with the UEs, thereby improving overall network performance. For example, the HRBB is similar to using a flashlight with adjustable focus. It creates many narrow beams, each very precise, to target users accurately. This improves signal quality and network efficiency because the beams can adapt to where users are located. The HRBB uses very narrow beams, which are great for focusing on specific users. However, these beams are so narrow that they divide the available frequency bands into smaller pieces. For reference, using a highway analogy, with too many narrow lanes (beams), there are not enough big lanes (frequency bands) left for multiple users to travel at the same time. This reduces the number of users who can use the network simultaneously.
Trade-off with FDM Efficiency: While the HRBB offers significant benefits in terms of beam alignment and spectral efficiency, it introduces challenges for UL FDM. The FDM is a technique used to allocate different frequency bands to multiple users simultaneously, enabling efficient resource utilization. In mmWave networks, the FDM allows multiple UEs to transmit data concurrently without interference. Since the HRBB spreads users across a larger number of finely quantized beams without changing beam width, fewer users fall within each beam. This reduces the number of UEs that can be multiplexed simultaneously in the UL, leading to underutilization of frequency resources. As a result, the system gains in beam precision, but loses in multiplexing capacity.
NRBB: An NRBB has fewer beams (e.g., 160 beams), but possess a broader coverage per beam, have a higher UE density per beam and enables efficient FDM as compared to an HRBB. Further the NRBB is suitable for cell-center UEs with strong SNR and lower beamforming needs.

The HRBB has many beams, for example, 1280 beams, and possesses high resolution and high-gain beams. The HRBB improves coverage and reliability, especially for cell-edge UEs suffering from high path loss at FR2 and reduces inter-beam interference for higher link quality. The HRBB is essential for mm Wave/FR2 deployment to overcome path loss and blockage and increase the coverage. It enables ultra-reliable and high-throughput links in dense networks, but in the HRBB the UE distribution becomes fragmented across beams, thereby lowering FDM opportunities.

Cell-center UEs: The Cell-center UEs are devices located near the center of a cellular network cell, benefiting from strong signal strength and stable connections. Using fewer beams with broader coverage is suitable for these UEs because they do not utilize advanced beamforming techniques, allowing for an efficient FDM and better resource utilization within the network. These are devices or users situated close to the BS or cell tower within a cellular network. In contrast, “cell-edge UEs” are located near the outer boundary of the cell. Cell-center UEs typically experience stronger SNR because they are closer to the BS. This strong signal strength reduces the need for advanced beamforming techniques, as the signal is not to be as precisely focused.

Cell-edge UEs: The Cell-edge UEs are devices located at the outer boundary of a cellular network cell, experiencing weaker signal strength and facing challenges in maintaining stable connections. These UEs benefit from advanced beamforming techniques, such as high-resolution beams, to focus the signal precisely on them and improve network performance. Broader beams are less suitable for cell-edge UEs due to increased interference and diluted signal strength. Because of their weaker signal strength, cell-edge UEs benefit significantly from advanced beamforming techniques. The HRBB can be used to focus the signal precisely on these users, improving their connection quality and overall network performance.

Scheduling in UL: The scheduler in a wireless network is responsible for allocating time, frequency, and beam resources to the UEs for UL transmission. This ensures efficient use of network resources and fair service to all users. An example flow of scheduling in UL includes:
1. Beam Sweeping: The network performs beam sweeping to identify the best beam for each UE. This includes testing multiple beams to find the one that provides the strongest signal.
2. Best Beam Identification: Once the best beam is identified for the UE, the network proceeds to the next step.
3. Proportional Fair (PF) Metric: The scheduler uses a PF metric to select a primary UE for resource allocation. This metric balances fairness and efficiency by considering both the user's data rate and waiting time.
4. Resource Allocation: Resources are allocated only to the UEs within the primary beam's coverage area.

The primary UE is the UE selected by the scheduler to receive resources within a specific beam. This selection is typically based on a metric like the PF mechanism, which balances fairness and efficiency by considering factors such as the UE's data rate and waiting time. Once the primary UE is selected, resources like time, frequency, and beam are allocated to this UE within the coverage area of the beam. Other UEs within the same beam may also receive resources, but the primary UE is the one that determines the initial allocation and the BS beam corresponding to this UE is selected for the transmission. After scheduling the primary UE, if residual bandwidth is available and secondary UEs have data to transmit, the remaining bandwidth frequency resources in a same time symbol is allocated to the secondary UEs in the same beam. But the primary UE is the one that determines the initial allocation.

In the HRBB, narrow beams result in equal to fewer UEs per beam and adjacent-beam overlap may be ignored for bandwidth underutilization. The core challenge is the HRBB improves link quality beamforming gain, interference reduction, but degrades UL FDM efficiency.

Efficient scheduling strategies are utilized to balance precision (HRBB) and multiplexing (NRBB).

Referring now to the drawings, and more particularly to FIGS. 1 through 8B, there are shown preferred embodiments.

FIG. 1 illustrates diagrams 100, 100′ depicting an example scheduling approach. In the example approach, the BS (101) performs beam sweeping with the HRBB, and each UE (102a-e, also referred to, individually or collectively, as 102 unless otherwise specified) identifies the best beam for itself, as shown in diagram 100 of FIG. 1. This information is given to the scheduler, which then calculates the PF metric for all UEs (102) and selects the UE (102) with the highest PF metric as the primary UE (102c). The beam corresponding to this primary UE (102c) is designated as the primary beam (103), as shown in diagram 100′ of FIG. 1. The example scheduling approach includes:

Beam Sweeping with HRBB: the BS (101) scans all high-resolution beams, for example, 1280 beams, to identify the best beam for each UE (102) as shown in FIG. 1. The UE selection is based on the PF metric balancing throughput and fairness.

Primary UE (102c) and primary beam (103) Scheduling: the BS (101) selects the highest-PF UE (102) as the primary UE (102c) and assigns its beam as the primary beam (103), and only UEs (102) within the primary beam (103) are scheduled, ignoring adjacent beams.

Resource Allocation: Residual bandwidth is allocated sequentially to UEs (102) in the same beam, having low FDM opportunity.

Key Characteristics of the example approach are:

Fixed Beam Books: the HRBB or NRBB operates independently without dynamic adaptation.

Single-Beam Focus: the scheduler optimizes for one beam at a time, underutilizing spatial overlap.

PF-Centric: Ensures fairness, but lacks any mechanism to exploit spatial overlap for multiplexing.

In the HRBB, the baseline has efficient user grouping, and the total number of scheduling chances increases with user density, but the problem in the HRBB is that fragmentation across narrow beams consistently underperforms the NRBB at all user densities. For example, at 20 UEs (102) per cell, the HRBB causes approximately 13,000 fewer total number of scheduling chances and approximately 10% UL capacity reduction. Due to this, resources are getting wasted, which affects the throughput and latency and hinders technology adoption. In the HRBB, expensive spectrum and bandwidth remain underutilized. The HRBB has longer waits and lower data rates for users, and the economic case for high-precision mmWave networks is weakened due to capacity sacrifice. The HRBB improves coverage at the cost of UL capacity. Some scheduling methods such as the example approach fail to solve this trade-off, and novel scheduling strategies as provided in this disclosure are essential to unlock the full 5G/6G mmWave uplink potential.

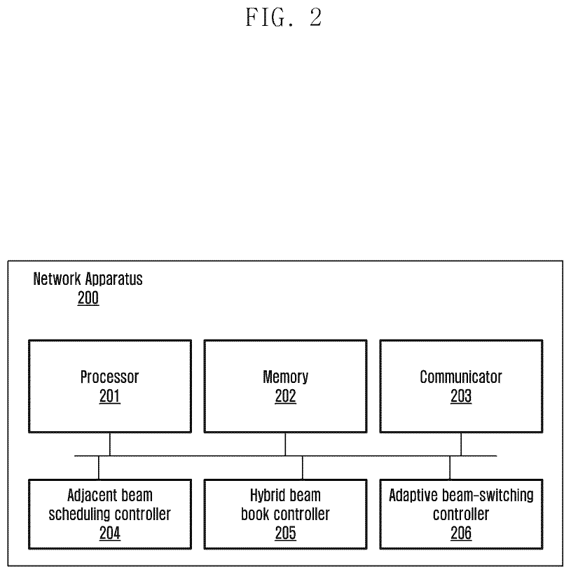

FIG. 2 illustrates a block diagram of a network apparatus according to example embodiments of the present disclosure. As illustrated in FIG. 2, the network apparatus (200) includes a processor (201), a memory (202), a communicator (203), an adjacent beam scheduling controller (204), a hybrid beam book controller (205), and an adaptive beam-switching controller (206).

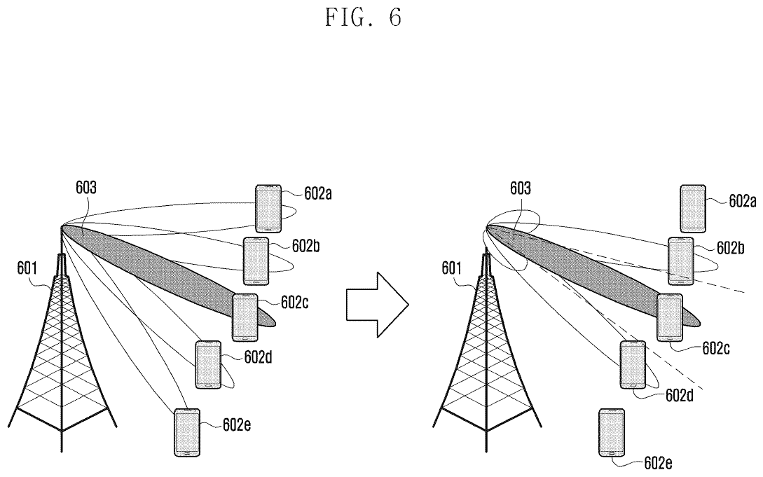

Examples of the network apparatus (200) include, but are not limited to, BSs (e.g., BS 601 of FIG. 6) (such as macro cells, small cells, femtocells, picocells, etc.) for wireless communication, Antennas and RF Units (e.g., MIMO beamforming) to enhance signal coverage and data throughput, Core Network Equipment (e.g., MMEs, S-GWs, P-GWs in 4G, AMFs, UPFs in 5G) for data routing, mobility, and session control, Network Function Virtualization (NFV) and Software-Defined Networking (SDN) for dynamic resource allocation and scalability, Edge Computing Nodes (e.g., MEC servers) for low-latency processing, Backhaul and Transport Equipment (e.g., fiber-optic links, microwave relays, Ethernet switches) to connect BSs (601) to the core network, Network Management Systems (NMS) and Operation Support Systems (OSS) for network configuration, fault management, and optimization, Radio Network Controllers (RNCs) in 3G, Distributed Units (DUs) and Centralized Units (CUs) in 5G, Network Slicing Components for virtualized resource allocation, and Security elements (e.g., Firewalls, IDS, AAA Servers) for secure communication.

The processor (201) manages scheduling UEs (e.g., the UEs 602 of FIG. 6) in a wireless communication system. Communication between the processor (201), the memory (202), the communicator (203), the adjacent beam scheduling controller (204), the hybrid beam book controller (205), and the adaptive beam-switching controller (206) is facilitated by the processor (201). The processor (201) executes instructions stored in the memory (202) and manages scheduling UEs (602) in a wireless communication system. The processor (201) may include one or a plurality of processors such as a Central Processing Unit (CPU), an Application Processor (AP), a Graphics Processing Unit (GPU), a Visual Processing Unit (VPU), and/or a Neural Processing Unit (NPU).

The memory (202) stores the operating system, application software, and temporary data used by the processor (201). Instructions to be executed by the processor (201) are stored in the memory (202). The memory (202) is not limited to volatile memory and/or non-volatile memory and may include a plurality of computer-readable storage media. Non-volatile storage elements such as magnetic hard disks, optical disks, floppy disks, flash memories, EPROM, or EEPROM memories may be included in the memory (202). In some examples, the memory (202) may be considered a non-transitory storage medium indicating that it is not embodied in a carrier wave or a propagated signal but not necessarily non-movable. The memory (202) stores the lookup tables of precoding vectors, beam IDs stored in the digital baseband, calibrated and used for scheduling decisions.

The communicator (203) facilitates communication between the UEs (602) and the network apparatus (200), supporting various communication protocols such as Transmission Control Protocol/Internet Protocol (TCP/IP), User Datagram Protocol (UDP), and second generation Digital Video Broadcasting by Satellite (DVB-S2). Internal communication between hardware components via one or more networks is also facilitated by the communicator (203). An electronic circuit specific to a standard that enables wired or wireless communication is included in the communicator (203).

In an embodiment, the adjacent beam scheduling controller (204) is a hardware component which provides a method and implementation of enhanced UL FDM scheduling with an HRBB. This hardware implementation ensures HRBB-based UL scheduling, FDM chance, and system throughput as the number of UEs (602) in a cell increases.

In an embodiment, the adjacent beam scheduling controller (204) performs beam sweeping using an HRBB where the beam sweeping determines a beam for each UE (602) of a plurality of UEs (602) and computes a scheduling metric for each UE (602) of the plurality of UEs (602). Further, the adjacent beam scheduling controller (204) selects a primary UE (602c) based on the highest scheduling metric among the plurality of UEs (602), where the beam corresponding to the primary UE (602c) is identified as a primary beam (603) and allocates communication resources to the primary UE (602c). Furthermore, the adjacent beam scheduling controller (204) determines whether residual bandwidth remains after allocation of the communication resources to the primary UE (602c) and schedules one or more additional UEs (602) using the residual bandwidth, where the one or more additional UEs (602) include secondary UEs located within the primary beam (603) and UEs (602) located in beams adjacent to the primary beam (603) and where the concurrent scheduling of the secondary UEs (602) and the UEs (602) in adjacent beams utilizes a spatial overlap to increase spectrum utilization.

In an embodiment, the adjacent beam scheduling controller (204) transmits reference signals across multiple beam directions where the adjacent beam scheduling controller (204) measures received signal quality for each UE (602) for each transmitted reference signal.

In an embodiment, the adjacent beam scheduling controller (204) ranks the plurality of UEs (602) by the scheduling metric and chooses the UE (602) with the highest rank.

In an embodiment, the adjacent beam scheduling controller (204) performs scheduling the one or more additional UEs (602) within the primary beam (603) subject to interference thresholds where the interference thresholds are established by the network apparatus (200).

In an embodiment, the adjacent beam scheduling controller (204) identifies a set of adjacent beams that have spatial overlap with the primary beam (603) where UEs (602) associated with the set of adjacent beams are aggregated into a common scheduling pool.

In an embodiment, the adjacent beam scheduling controller (204) dynamically combines HRBB-based beam selection and FDM-based resource allocation to increase multiplexing opportunities and uplink throughput.

In an embodiment, the hybrid beam book controller (205) is a hardware component which provides a method and implementation of enhanced uplink FDM scheduling with high-resolution beam book. This hardware implementation ensures HRBB-based uplink scheduling, FDM chance, and system throughput as the number of UEs (602) in a cell increases.

In an embodiment, the hybrid beam book controller (205) configures a beam book including a plurality of beam types for coverage of different cell regions including the HRBBs for cell-edge coverage and NRBBs for cell-center coverage, where the beam book includes a plurality of beam entries. Further, the hybrid beam book controller (205) performs beam sweeping within the beam book to obtain beam measurements for each mapped UE (602), processes the beam measurements to produce scheduling metrics for each UE (602), where the scheduling metrics include at least one of channel quality indicator, UE priority, UE's current data rate, historical average throughput, buffer occupancy level, and spatial overlap coefficient, and selects a primary UE (602c) based on the scheduling metrics, the primary beam (603) associated with the primary UE (602c), and scheduling the primary UE (602c) on an associated beam, where UEs (602) mapped to the HRBBs are prioritized over UEs (602) mapped to the NRBBs when selecting the primary UE (602c). Furthermore, the hybrid beam book controller (205) allocates residual bandwidth to one or more additional UEs (602) based on the scheduling metrics, where allocation includes scheduling secondary UEs (602) in the primary beam (603) and UEs (602) mapped to NRBBs based on the scheduling metrics to increase multiplexing efficiency and instantiates the scheduling decision by provisioning resource grants and control signaling to the scheduled UEs (602), where the beam book is predefined or dynamically reconfigurable to balance cell-edge coverage and cell-center multiplexing.

In an embodiment, the hybrid beam book controller (205) dynamically combines HRBB-based beam selection and FDM to increase UL throughput and FDM opportunities in mmWave bands.

In an embodiment, the beam-switching controller (206) is a hardware component which provides a method and implementation of enhanced UL FDM scheduling with an HRBB. This hardware implementation ensures HRBB-based UL scheduling, FDM chance, and system throughput as the number of UEs (602) in a cell increases.

In an embodiment, the adaptive beam-switching controller (206) initializes a dual-beam book comprising HRBBs for precise directional transmission and NRBBs for broader coverage, determines an optimal beam for each UE (602) by performing beam sweeping using the HRBBs based on at least one of signal quality or geographical position, and identifies a primary UE (602c) having the highest scheduling metric and one or more secondary UEs (602) having next-highest scheduling metrics within the same HRBB and adding the primary UE (602c) and the one or more secondary UEs (602) to a scheduled-UE list. Further, the adaptive beam-switching controller (206) determines bandwidth consumed by the primary UE (602c) and the one or more secondary UEs (602) and compares the consumed bandwidth with the total available bandwidth, retains the HRBB for the primary UE (602c) and the one or more secondary UEs (602) when the consumed bandwidth equals the total available bandwidth, where the retention maintains spectral efficiency, and switches to a corresponding NRBB for the same angular region to utilize residual bandwidth and to schedule additional UEs (602) using broader coverage when the consumed bandwidth is less than the total available bandwidth. Furthermore, the adaptive beam-switching controller (206) computes scheduling metrics for UEs (602) mapped to the NRBB, schedules UEs (602) in the NRBB having the highest scheduling metrics until the bandwidth is fully utilized, and implements a scheduling outcome comprising UEs (602) scheduled from both HRBBs and NRBBs.

In an embodiment, the adaptive beam-switching controller (206) combines HRBB-based beam selection and FDM to improve throughput and FDM opportunities in the wireless communication system.

In an embodiment, the adaptive beam-switching controller (206) initially schedules high-priority UEs (602) using a high-gain HRBB and switches to a wider NRBB to schedule additional lower-priority UEs (602) in the same angular region when residual bandwidth is available.

In an embodiment, the adaptive beam-switching controller (206) dynamically switches between the HRBB and the NRBB in the same angular region based on residual bandwidth. The beam-switching controller schedules UEs (602) using a high-resolution beam in the angular region, determines whether residual bandwidth remains after allocating bandwidth to high-priority UEs (602), and switches to a corresponding normal-resolution beam in the angular region to schedule additional UEs (602) within the residual bandwidth, where the switching between beam types is opportunistic to maximize resource utilization on a per-interval basis.

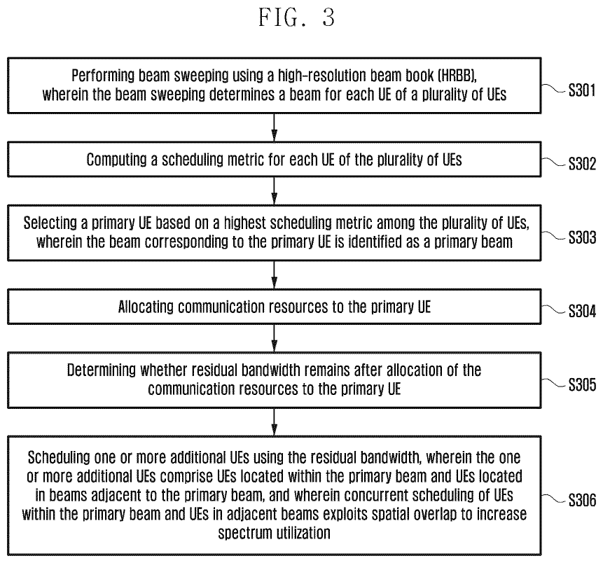

FIG. 3 illustrates a flow chart for an adjacent beam UEs scheduling method according to example embodiments of the present disclosure. At step 301, a network apparatus (e.g., the network apparatus 200 of FIG. 2) may perform beam sweeping using an HRBB. The beam sweeping determines a beam for each UE (e.g., UE 602 of FIG. 6) of a plurality of UEs (602). The HRBB includes a plurality of beam entries, where each beam entry defines at least one of a beam direction, a beam width, or a beam gain. The beam sweeping also includes transmitting reference signals across multiple beam directions and measuring received signal quality for each UE (602) for each transmitted reference signal.

At step 302, the network apparatus (200) may compute a scheduling metric for each UE of the plurality of UEs (602). The scheduling metric is computed based on at least one of channel quality, UE (602) priority, buffer occupancy, UE's current data rate, historical average throughput, or a spatial overlap factor. Further, at step 303, network apparatus (200) may select a primary UE (602c) based on the highest scheduling metric among the plurality of UEs (602). The beam corresponding to the primary UE (602c) is identified as a primary beam (603). The primary UE (602c) is selected by ranking the plurality of UEs (602) by the scheduling metric and choosing the UE (602) with the highest rank.

At step 304, the network apparatus (200) may allocate communication resources to the primary UE (602c). Furthermore, at step 305, the network apparatus (200) may determine whether residual bandwidth remains after the allocation of communication resources to the primary UE (602c). At step 306, the network apparatus (200) may schedule one or more additional UEs (602) using the residual bandwidth. The one or more additional UEs (602) may include secondary UEs (non-primary UEs) located within the primary beam (603) and UEs (602) located in beams adjacent to the primary beam (603). The secondary UEs and the UEs located in the adjacent beams may be scheduled in the primary beam (603). Concurrent scheduling of the secondary UEs (602) and the UEs (602) in the adjacent beams utilizes spatial overlap to increase spectrum utilization. The scheduling of the one or more additional UEs (602) (603) is performed subject to interference thresholds established by the network apparatus (200).

In an embodiment, the proposed method includes the network apparatus (200) identifying a set of adjacent beams that have spatial overlap with the primary beam (603). UEs (602) associated with the set of adjacent beams are aggregated into a common scheduling pool, and UL transmissions from the aggregated UEs (602) in the common scheduling pool are scheduled within a single FDM opportunity.

In an embodiment, the network apparatus (200) dynamically combines HRBB-based beam selection and FDM-based resource allocation to increase multiplexing opportunities and uplink throughput.

In a further embodiment, the concurrent scheduling of the one or more additional UEs (602) is performed in the primary beam (603) while maintaining beamforming precision, minimizing inter-beam interference during concurrent scheduling.

The scheduling method is applicable to at least one of uplink communication and downlink communication.

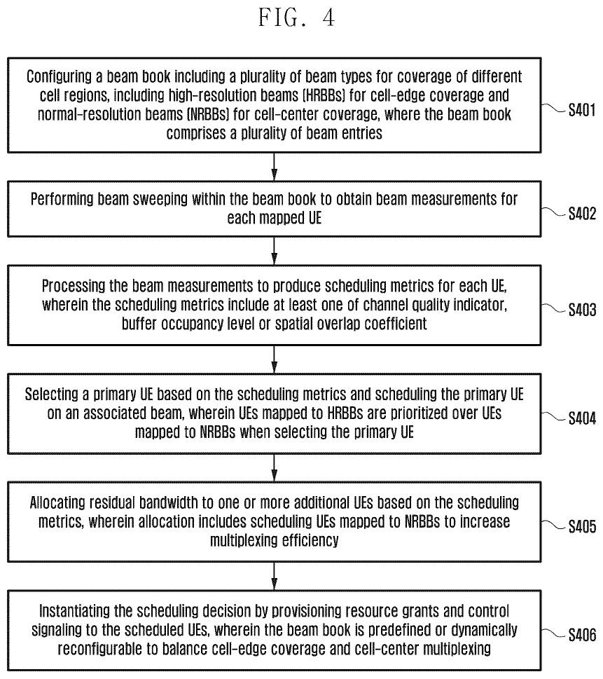

FIG. 4 illustrates a flow chart for a hybrid beam book scheduling method according to example embodiments of the present disclosure. At step 401, a network apparatus (e.g., the network apparatus 200 of FIG. 2) may configure a beam book comprising a plurality of beam types for coverage of different cell regions. This includes HRBBs for cell-edge coverage and NRBBs for cell-center coverage, where the beam book includes a plurality of beam entries. The beam book includes fixed configurations comprising combined HRBB and NRBB beam entries to balance capacity and multiplexing.

At step 402, the network apparatus (200) may perform beam sweeping within the beam book to obtain beam measurements for each mapped UE (e.g., UE 602 of FIG. 6). At step 403, the network apparatus (200) may process the beam measurements to produce scheduling metrics for each UE (602). The scheduling metrics include at least one of channel quality indicator, buffer occupancy level, UE priority, UE's current data rate, historical average throughput, or spatial overlap coefficient.

At step 404, the network apparatus (200) may select a primary UE (602c) based on the scheduling metrics, the primary beam (603) associated with the primary UE (602c), and scheduling the primary UE (602c) on an associated beam. UEs (602) mapped to HRBBs are prioritized over UEs mapped to NRBBs when selecting the primary UE (602c).

At step 405, the network apparatus (200) may allocate residual bandwidth to one or more additional UEs (602) based on the scheduling metrics. Allocation includes scheduling secondary UEs (602) in the primary beam (603) and UEs (602) mapped to NRBBs based on the scheduling metrics to increase multiplexing efficiency.

At step 406, the network apparatus (200) may instantiate the scheduling decision by provisioning resource grants and control signaling to the scheduled UEs (602). The beam book is predefined or dynamically reconfigurable to balance cell-edge coverage and cell-center multiplexing.

In an embodiment, the scheduling framework dynamically combines HRBB-based beam selection and FDM to increase UL throughput and FDM opportunities in mmWave bands. HRBBs provide higher gain and narrower beamwidth to ensure precise alignment for cell-edge UEs, while NRBBs provide wider beamwidth to group multiple cell-center UEs and maximize FDM opportunities. The beam book is a hybrid beam book comprising HRBB and NRBB entries in fixed configurations or in dynamically adjustable configurations.

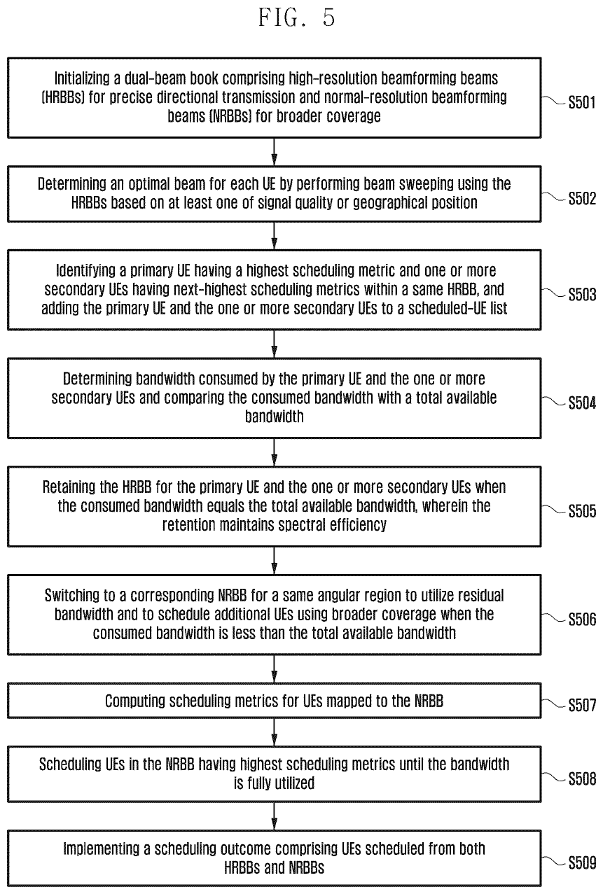

FIG. 5 illustrates a flow chart for an adaptive beam-switching method according to example embodiments of the present disclosure. At step 501, the network apparatus (200) may initialize a dual-beam book comprising HRBBs for precise directional transmission and NRBBs for broader coverage. At step 502, the network apparatus (200) may determine an optimal beam for each UE (602) by performing beam sweeping using the HRBBs based on at least one of signal quality or geographical position. At step 503, the network apparatus (200) may identify a primary UE (602c) having the highest scheduling metric and one or more secondary UEs (602) having the next-highest scheduling metrics within the same HRBB, and add the primary UE (602c) and the one or more secondary UEs (602) to a scheduled-UE list.

At step 504, the network apparatus (200) may determine the bandwidth consumed by the primary UE (602c) and the one or more secondary UEs (602) and compare the consumed bandwidth with the total available bandwidth. At step 505, the network apparatus (200) may retain the HRBB for the primary UE (602c) and the one or more secondary UEs (602) when the consumed bandwidth equals the total available bandwidth, where the retention maintains spectral efficiency. At step 506, the network apparatus (200) may switch to a corresponding NRBB for the same angular region to utilize residual bandwidth and to schedule additional UEs (602) using broader coverage when the consumed bandwidth is less than the total available bandwidth.

At step 507, the network apparatus (200) may compute scheduling metrics for UEs (602) mapped to the NRBB. At step 508, the network apparatus (200) may schedule UEs (602) in the NRBB having the highest scheduling metrics until the bandwidth is fully utilized. At step 509, the network apparatus (200) may implement a scheduling outcome comprising UEs (602) scheduled from both HRBBs and NRBBs.

In an embodiment, the network apparatus (200 may combine HRBB-based beam selection and FDM to improve throughput and FDM opportunities in the wireless communication system. Another embodiment includes the network apparatus (200) initially scheduling high-priority UEs (602) using a high-gain HRBB and switching to a wider NRBB to schedule additional lower-priority UEs (602) in the same angular region when residual bandwidth is available.

In an embodiment, the network apparatus (200) dynamically switches between the HRBB and the NRBB in the same angular region based on residual bandwidth. The network apparatus (200) schedules UEs (602) using a high-resolution beam in the angular region, determines whether residual bandwidth remains after allocating bandwidth to high-priority UEs (602), and switches to a corresponding normal-resolution beam in the angular region to schedule additional UEs (602) within the residual bandwidth. This switching between beam types is opportunistic to maximize resource utilization on a per-interval basis.

Thus, the example embodiments in accordance with the present disclosure introduce a scheduling framework for mmWave UL networks that dynamically combines HRBB and FDM techniques. The example embodiments introduce novel mechanisms such as adjacent beam scheduling, hybrid beam books, and adaptive beam-switching to optimize resource utilization. This framework significantly improves UL throughput by up to 77% for cell-edge UEs (602) and increases FDM opportunities by 236% in 5G/6G mmWave networks, addressing the critical industry challenge of balancing beamforming precision and spectral efficiency.

The example embodiments in accordance with the present disclosure also resolve the trade-off between HRBB and uplink FDM efficiency in mmWave networks, where HRBB's narrow beams reduce concurrent UE scheduling opportunities. Adjacent beam scheduling aggregates UEs (602) from overlapping HRBB beams to boost FDM. Hybrid beam books with fixed HRBB/NRBB zones for cell-edge/cell-center UEs (602) and adaptive beam-switching dynamically select HRBB/NRBB based on real-time bandwidth demand.

The example embodiments in accordance with the present disclosure redefine mmWave UL scheduling by enabling simultaneous high beamforming gain and multiplexing, previously considered mutually exclusive, through intelligent beam management. The example embodiment in accordance with the present disclosure provide the first framework to dynamically reconcile HRBB's precision with NRBB's multiplexing gains, validated via system-level simulations showing a 236% FDM improvement at 500 m ISD.

The example embodiments in accordance with the present disclosure further address the limitations of high-resolution beamforming in FR2 by introducing an enhanced scheduling approach that enhances FDM chances, allowing more UEs (602) to be covered and scheduled simultaneously within a single beam. By improving beam management and resource allocation techniques, the example embodiments in accordance with the present disclosure maximize system throughput, balance user distribution, and effectively increase FDM chances, offering a significant performance boost for mmWave communication systems in dense environments. For example, at 500 m ISD, the number of FDM chances is increased by all the proposals compared to Advanced AU, and UL UE (602) throughput is increased compared to Base AU and Advanced AU.

An overview of the example embodiments in accordance with the present disclosure is given below. The adjacent beam scheduling method leverages the inherent spatial overlap between neighboring high-resolution beams with a mechanism where the scheduler aggregates UEs (602) across a cluster of adjacent beams rather than restricting scheduling to a single primary beam (603). This approach allows UEs (602) in overlapping high-resolution beams to contribute simultaneously rather than restricting to a primary UE's (602c) beam, increasing the number of UEs (602) available for FDM within the HRBB framework without compromising beam precision. The approach is straightforward to implement and yields substantial performance gains.

The hybrid beam book scheduling method utilizes a fixed predefined beam book combining both HRBB and NRBB beams. Cell-Edge Regions are served by HRBB beams to ensure high gain and precise alignment for users at the cell edge, while Cell-Center Regions are served by NRBB beams to group multiple users broadly, maximizing FDM opportunities. This method achieves an optimized balance of coverage and capacity by design and reduces computational complexity by employing a fixed configuration while simultaneously addressing edge and center user requirements.

The adaptive beam-switching method dynamically alternates between HRBB and NRBB within the same angular region based on instantaneous traffic demand. The method initially schedules high-priority UEs (602) using a high-gain HRBB beam. If residual bandwidth is available, it switches to a wider NRBB beam to schedule additional lower-priority UEs (602) in the same region. This method enables opportunistic real-time maximization of spectral resources, adapting automatically to traffic conditions without manual intervention, thereby enhancing overall uplink efficiency.

FIG. 6 illustrates diagrams depicting an adjacent beam scheduling method according to example embodiments of the present disclosure. The scheduling approach with adjacent beam scheduling performs beam sweeping with the HRBB to determine the best beam for each UE (602a-e, also referred to, individually or collectively, as 602 unless otherwise specified) and identifies the primary UE (602c), selecting its beam as the primary beam (603). This determining process includes computing the PF metric for all UEs (602) and selecting the UE (602) with the highest PF metric as the primary UE (602c) and the best beam for the primary UE (602c). The PF metric balances fairness and throughput by prioritizing UEs (602) with good channel conditions and those that have been underserved.

The scheduling approach with adjacent beam scheduling then checks bandwidth requirements. If the primary UE's bandwidth requirement equals or exceeds the total available bandwidth, only the primary UE (602c) is scheduled. If residual bandwidth is available, the process proceeds to schedule secondary UEs (602). It checks for secondary UEs (602) in the best beam, computes their PF metrics, and schedules the UEs (602) with the highest PF metric.

In an embodiment, if no secondary UEs (602) are available in the best beam or if additional bandwidth is still available, UEs (602) in the adjacent beams that overlap with the primary beam (603) are identified. The UE(s) (602) with the highest PF metrics from adjacent beams are selected and scheduled in the residual bandwidth. The scheduling approach then outputs the final scheduling decisions, including primary UEs (602c) and secondary UEs (602) from the best beam and UEs (602) from adjacent beams.

In an embodiment, if there are multiple UEs (602) with similar PF metrics in adjacent beams, any UE (602) with similar PF metrics will be scheduled. For example, suppose BS (601) has 800 MHz bandwidth and there is a primary UE (602c) consuming 400 MHz BW and a secondary UE (602) in the same beam also consuming 400 MHz BW. In this case, the UEs (602) from the adjacent beam will not be scheduled. Conversely, if BS (601) has 800 MHz bandwidth and there is a primary UE (602c) consuming 400 MHz BW with no secondary UE (602) in the same beam, the residual BW is 400 MHz. The UEs (602) in the adjacent beams are then identified, and the requested frequency resources from this residual BW of 400 MHz are allocated. The UE(s) (602) will be scheduled as per the PF metric.

In an embodiment, the overlap between adjacent beams and the primary beam (603) occurs by selecting the adjacent beams greater than a set threshold (e.g., 0.25/0.5). The criteria for selecting UEs (602) from adjacent beams include:
1. If bandwidth is available after scheduling the UEs (602) in the primary UE's (602c) beam.
2. If UE(s) (602) is/are available in the adjacent beams.

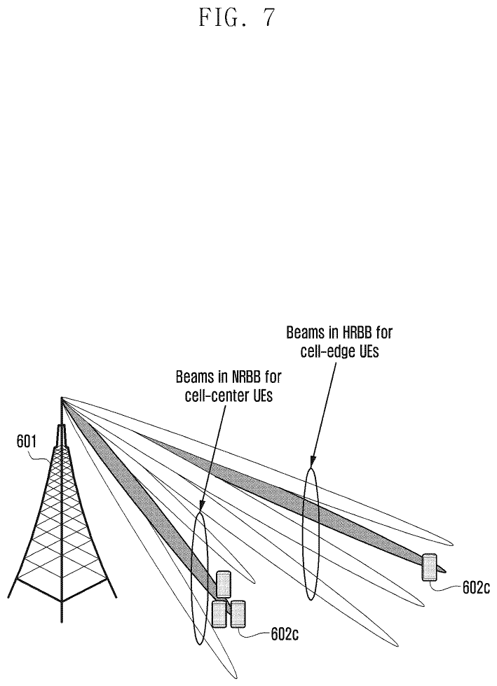

FIG. 7 illustrates a diagram depict a hybrid beam book scheduling method according to embodiments disclosed herein. In an embodiment, as illustrated, since the HRBB can increase the cell coverage, cell edge users are served by the beam in HRBB, while cell center users are served by normal resolution BB. Based on the PF metric, the primary user and its serving beam are selected and scheduled first.

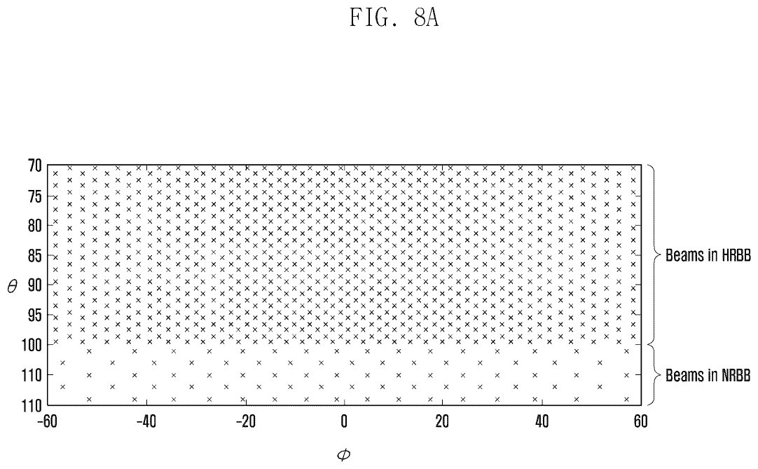

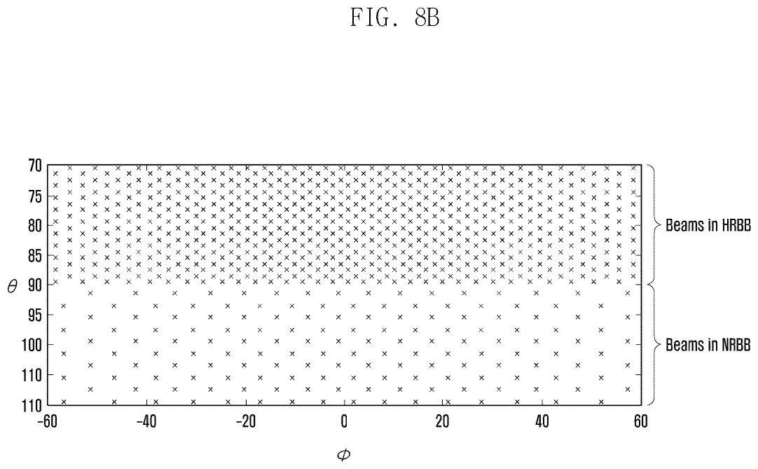

FIGS. 8A-8B illustrate diagrams depicting a 1040-beam hybrid beam book and a 800-beam hybrid beam book, respectively, according to example embodiments of the present disclosure. FIGS. 8A-8B illustrate two examples of hybrid beam books: the 1040-beam hybrid beam book and the 800-beam hybrid beam book. Here, specific beams are allocated to cover designated angular ranges, where x and y axes represent azimuth ¢ and elevation θ, respectively. These configurations are fixed and do not dynamically adjust based on real-time network conditions or UE (e.g., UE 602 of FIG. 6) distribution.

The 1040-beam hybrid beam book shown in FIG. 8A includes:
1. The HRBBs Cell-edge region, 960 beams: HRBB beams cover the angular range from 70 to 100, ensuring precise, focused coverage for UEs (602) at the cell's edge.
2. NRBBs (Cell-center region, 80 beams): NRBB beams cover the angular range from 100 to 110, providing sufficient coverage for UEs (602) near the BS (e.g., BS 601 of FIG. 6 or 7).

The 800-beam hybrid beam book shown in FIG. 8B includes:
1. HRBBs (Cell-edge region, 640 beams): HRBB beams cover the angular range from 70 to 90, providing high precision for UEs (602) at the cell's edge.
2. NRBBs (Cell-center region, 160 beams): NRBB beams cover the angular range from 90 to 110, offering broader coverage for UEs (602) closer to the BS (601).

In an embodiment, the mechanism flow for the hybrid beam book scheduling includes:

Select Predefined Hybrid Configuration: Deploy a fixed hybrid beam book, such as the 1040-Beam or 800-Beam, with designated HRBB and NRBB angular regions.

UE Grouping by Beam Region: Cell-Edge UEs are automatically assigned to HRBB beams e.g., 70°-100° with 960 beam for 1040-Beam book based on their angular position and Cell-Center UEs (602) are assigned to NRBB beams (e.g., 100°-110° with 80 beams for 1040-Beam book), ensuring efficient coverage.

Beam Sweeping and Fairness Evaluation: Perform beam sweeping and compute PF metrics for UEs (602) and determine the best beam of each UE (602).

Priority Scheduling: Schedule the highest PF metric UE (602) with its HRBB beam first, ensuring cell-edge UEs (602) receive priority.

Perform bandwidth requirements and identify secondary UEs (602) in the best beam from adjacent beam UEs (602) scheduling and allocates residual bandwidth to UEs (602) in NRBB beams, optimizing spectral efficiency.

Finalize Scheduling: Generate final scheduling decisions, prioritizing HRBB UEs (602) for precision and NRBB UEs (602) for multiplexing.

In an embodiment, the beam book is defined by combining HRBB and NRBB as illustrated in FIGS. 8A-8B, the HRBB covers the angular range from 70 to 100, with 960 beams and NRBB covers the angular range from 100 to 110, with 80 beams by using this the proposed solution automatically assigning cell-edge UEs (602) to HRBB beams and cell-center UEs (602) to NRBB beams.

In an embodiment, the final scheduling decisions are sent to UEs (602) via PDCCH DCI message on the selected beam.

In an embodiment, adaptive beam-switching introduces a dynamic beam-switching mechanism that leverages the coexistence of HRBB and NRBB at the BS (601) for PUSCH.

In an embodiment, adaptive beam-switching assuming the BS (601) is equipped with both HRBB and NRBB, the system dynamically selects the optimal beam book based on real-time bandwidth utilization, balancing spectral efficiency and FDM opportunities. The mechanism includes:

Dual-Beam Book Initialization: The BS (601) maintains two beam books: HRBB including high-resolution beams (e.g., 1280 beams) for precise directional transmission and NRBB including normal-resolution beams (e.g., 160 beams) for multiplexing multiple UEs (602).

Determine the best beam for each UE (602): Perform beam sweeping with the HRBB to determine the best beam for each UE (602).

Identify Primary UE (602c) and Secondary UEs (602): Primary UE (602c): The UE (602) with the highest PF metric in the HRBB beam. Secondary UE (602): The UE (602) with the second-highest PF metric in the same HRBB beam and adds primary UE (602c) and secondary UE (602) to the scheduled UEs (602) list.

Bandwidth Consumption Check: Calculate the bandwidth consumed by the primary UEs (602c) and secondary UEs (602): Bconsumed=BprimaryUE+BsecondaryUE and Compare Bconsumed to the total bandwidth Btotal.

Beam-Switching Decision: If (Bconsumed=Btotal): Retain HRBB for the primary UEs (602c) and secondary UEs (602) to maintain high spectral efficiency and If (Bconsumed<Btotal): Switch to NRBB for the same angular region to utilize residual bandwidth and Schedule additional UEs (602). UEs (602) other than already scheduled UEs (602) in the NRBB beam using broader coverage.

NRBB Scheduling: Compute PF metrics for UEs (602) in the NRBB beam and Schedule UEs (602) with the highest PF metrics until bandwidth is fully utilized.

In an embodiment, the specific characteristics of the HRBB is narrow, high-gain, large number of beams fragmented but precise and NRBB is wide, lower-gain, fewer beams efficient multiplexing but less precise. They are maintained by lookup tables of precoding vectors (beam IDs), stored in the digital baseband, calibrated, and used for scheduling decisions.

The novelty, difference and impact of the example embodiments in accordance with the present disclosure may be in the adjacent beam scheduling where a scheduler aggregates UEs (602) across neighboring HRBB beams that have a spatial overlap. Some systems restrict to UEs (602) in a single beam, whereas the example embodiments in accordance with the present disclosure extend scheduling UEs (602) in multiple adjacent beams, thereby increasing UE pooling with higher multiplexing opportunities, e.g., in the hybrid beam book scheduling where a fixed hybrid beam book that mixes HRBB (edge) and NRBB (center) is introduced. Other solutions use either HRBB or NRBB for the entire cell but the proposed solution defined a zonal architecture. The hybrid beam book has strong edge coverage and efficient multiplexing at center and in adaptive beam-switching scheduling dynamically switch between HRBB and NRBB in the same angular region depending on residual bandwidth. In the other solutions, beam assignment is static, but the example embodiments in accordance with the present disclosure introduce a real-time adaptive switching logic. The example embodiments in accordance with the present disclosure maximize resource utilization per scheduling interval, avoiding wasted bandwidth.

The advantages of the adjacent beam scheduling method in accordance with the present disclosure lie in its ability to optimize scheduling by leveraging beam overlap within HRBB. This approach increases FDM opportunities by scheduling more UEs (602) concurrently, as it considers not only the best beam but also adjacent beams that may cover overlapping UE sets. By utilizing beam overlap, the adjacent beam scheduling improve resource utilization, ensuring that more UEs (602) are accommodated within the available bandwidth, even if they are located in neighboring beams. Furthermore, this method enhance UL throughput, especially in dense UE (602) scenarios, where the demand for resources is high. The adjacent beam scheduling method effectively balance fairness and throughput by using the PF metric to prioritize UEs (602) with good channel conditions, leading to a more efficient and equitable allocation of resources.

Hybrid beam book scheduling: The fixed allocation of beams ensures optimized beam coverage by assigning HRBB to the cell-edge regions and NRBB to the cell-center regions. The beam book allocation maximizes efficiency by ensuring that UEs (602) in each region receive the most suitable beam type, based on their location. Additionally, using fixed configurations eliminates the need for dynamic adjustments based on UE movement or network conditions, reducing computational complexity. Finally, by efficiently distributing HRBB and NRBB across different angular regions, the hybrid beam book scheduling method in accordance with the present disclosure strike an effective balance between precise beamforming for cell-edge UEs (602) and broader coverage for cell-center UEs (602), leading to improved scheduling efficiency and overall system performance.

Adaptive Beam-Switching Scheduling: The adaptive beam switching mechanism of Adaptive Beam-Switching Scheduling dynamically selects HRBB and NRBB within the same angular region based on real-time bandwidth requirements. This balances spectral efficiency and FDM opportunities, with HRBB providing precise high-gain transmission for critical UE (602) and NRBB enabling concurrent scheduling of multiple UEs (602) to effectively utilize the remaining bandwidth. In addition, it seamlessly adapts to fluctuating traffic patterns without manual intervention, thereby improving scheduling efficiency based on real-time conditions.

The example embodiments in accordance with the present disclosure target UL FDM scheduling efficiency in HRBB-based 5G mmWave systems, which are highly relevant to 3GPP and industry standardization. The Adjacent Beam Scheduling, Hybrid Beam Book, and Adaptive Beam-Switching methods in accordance with the present disclosure are built on top of standard PF scheduling and beam training mechanisms widely adopted in mmWave NR.

The example embodiments may deliver 23-77% UL throughput gain and substantial FDM ratio improvement, making them difficult to bypass without performance degradation.

Table I below shows some simulation parameters.

TABLE I
Simulation parameters

| | |
|---|---|
| Parameter | Value |

| Number of cells | 1 tier (21 cells) | |
|---|---|---|
| Carrier frequency | 28 | GHz |
| Channel bandwidth | 800 | MHz |
| Traffic model | Full buffer, 1000 slots | |
| Slot configuration | DDDFU | |
| Scheduler | Greedy - SU | |
| BS antenna configuration | (M, N, P, Mp, Np) = (24, 16, 2, 1, 1) | |
| Minimum distance | 35 | m |
| Mechanical downtilt | 10 | degree |
| UE antenna configuration | (M, N, P, Mp, Np) = (8, 8, 2, 1, 1) | |
| Maximum EIRP at BS | 84 | dBm |
| Maximum EIRP at UE | 46 | dBm |
| Maximum number of | 2 | |
| layers per UE | | |
| P0 | −104 | |
| Alpha | 1 | |
| UL Scheduler | UL Contiguous RB scheduler | |
| UL capability | Up to 400 MHz | |
| UE speed | 0.1 | kmph |

Baseline (Base AU): An Antenna Unit (AU) with 24 V × 16 H × 2 P antenna configuration and 160 normal resolution beams at the BS (601).
Advanced AU: An AU built on Base AU which employs a 48 V × 16 H × 2 P antenna configuration and 1280 high resolution beams at the BS (601).
Adjacent Beam Scheduling (also referred to herein as Proposal 1): Advanced AU + adjacent beam UEs (602) scheduling, Uma, 1280 beams at the BS (601).
Hybrid Beam Book Scheduling (also referred to herein as Proposal 2): Advanced AU + Hybrid beam book, Uma, 800 beams at the BS (601).
Adaptive Beam-Switching Scheduling (also referred to herein as Proposal 3): Advanced AU + adaptive HRBB/NRBB switching, Uma, 1280 (HRBB)/800 (NRBB) beams at the BS (601).

A significant increase in the number of FDM chances can be seen with the Adjacent Beam Scheduling, Hybrid Beam Book Scheduling, and Adaptive Beam-Switching Scheduling methods in accordance with the present disclosure, as compared to Advanced AU, but the number of the FDM chances is still lower than Base AU.

As the UEs (602)/cell increases, the number of FDM chance increases.

As the ISD increases, the number of FDM chance increases.

For 500 m ISD, the UE UL throughput is also increased as compared to Advanced AU and Base AU, but it is still lower for 200 m ISD than Base AU.

Table II below shows total numbers of scheduling chances (500 m ISD).

TABLE II
Total numbers of scheduling chances (500 m ISD)

| | 5 | 10 | 15 | 20 | 25 |
|---|---|---|---|---|---|
| | UE/cell | UE/cell | UE/cell | UE/cell | UE/cell |
| Base AU | 121405 | 131575 | 139352 | 149544 | 156557 |
| Advanced AU | 114266 | 116454 | 116247 | 117471 | 118350 |
| Proposal 1 | 120486 | 128833 | 134282 | 140915 | 146337 |
| Proposal 2 | 114759 | 117570 | 118017 | 119716 | 121824 |
| Proposal 3 | 120561 | 128748 | 134065 | 140860 | 146234 |

Table III below shows FDM Ratio.

TABLE III
FDM Ratio

| | 5 | 10 | 15 | 20 | 25 |
|---|---|---|---|---|---|
| | UE/cell | UE/cell | UE/cell | UE/cell | UE/cell |
| Base AU | 0.0706 | 0.1603 | 0.2289 | 0.3187 | 0.3806 |
| Advanced AU | 0.0076 | 0.0269 | 0.0251 | 0.0359 | 0.0437 |
| Proposal 1 | 0.0625 | 0.1361 | 0.1841 | 0.2436 | 0.2904 |
| Proposal 2 | 0.0120 | 0.0368 | 0.0407 | 0.0557 | 0.0743 |
| Proposal 3 | 0.0631 | 0.1353 | 0.1822 | 0.2422 | 0.2895 |

Table IV below shows CPE Throughput for 500 m ISD.

TABLE IV
CPE throughput

| | 5 UE/cell | | | 10 UE/cell | | |
|---|---|---|---|---|---|---|
| DL/UL | Average | 80%-tile | 5%-tile | Average | 80%-tile | 5%-tile |
| Base AU | 545.7/37.0 | 795.7/51.6 | 112.8/9.0 | 269.3/19.1 | 405.4/26.8 | 66.5/6.1 |
| Adv. AU | 773.5/44.2 | 904.6/58.1 | 318.1/15.7 | 379.0/23.0 | 496.4/30.1 | 169.9/9.4 |
| Prop. 1 | 773.0/45.6 | 904.6/60.2 | 332.0/15.9 | 378.8/24.2 | 496.4/31.8 | 170.2/9.8 |
| Prop. 2 | 765.1/43.6 | 899.1/57.5 | 304.4/14.4 | 375.4/22.7 | 496.4/29.7 | 158.2/9.5 |
| Prop. 3 | 774.8/45.6 | 901.8/60.7 | 327.2/15.7 | 379.1/24.3 | 496.4/31.8 | 167.8/10.2 |

| | 15 UE/cell | | | 20 UE/cell | | |
|---|---|---|---|---|---|---|
| DL/UL | Average | 80%-tile | 5%-tile | Average | 80%-tile | 5%-tile |
| Base AU | 180.3/14.2 | 278.5/19.3 | 45.2/3.9 | 134.3/11.6 | 204.1/15.7 | 34.9/3.2 |
| Adv. AU | 253.6/15.1 | 311.6/19.6 | 122.2/6.0 | 189.0/11.4 | 228.9/15.1 | 98.4/4.7 |
| Prop. 1 | 253.5/16.3 | 310.0/21.7 | 122.3/6.0 | 188.9/12.7 | 228.9/16.5 | 98.0/5.3 |
| Prop. 2 | 251.4/15.1 | 307.6/20.0 | 118.5/5.9 | 188.9/11.5 | 228.9/15.2 | 97.8/4.7 |
| Prop. 3 | 253.2/16.3 | 307.6/21.6 | 123.7/6.1 | 188.9/12.5 | 228.8/16.5 | 96.7/4.7 |

| | 25 UE/cell | | |
|---|---|---|---|
| DL/UL | Average | 80%-tile | 5%-tile |
| Base AU | 107.6/9.7 | 165.5/13.2 | 26.9/2.5 |
| Adv. AU | 150.7/9.1 | 184.8/12.1 | 74.6/3.4 |
| Prop. 1 | 150.7/10.2 | 184.8/13.9 | 74.2/3.4 |
| Prop. 2 | 149.2/9.2 | 184.8/12.4 | 72.1/3.4 |
| Prop. 3 | 150.6/10.2 | 184.8/13.9 | 73.5/3.4 |

Adjacent Beam Scheduling: The UE UL throughput is increased by 5-27% for 50%-tile, 5-19% for 80%-tile, and 36-77% for 5%-tile as compared to Base AU and The UE UL throughput is increased by 3-10% for 50%-tile, 4-11% for 80%-tile, and 1-4% for 5%-tile as compared to Advanced AU.
Hybrid Beam Book Scheduling: The UE UL throughput is increased as compared to Base AU and Advanced AU.
Adaptive Beam-Switching Scheduling: The UE UL throughput is increased as compared to Base AU and Advanced AU.

Table V below shows total numbers of scheduling chances (200 m ISD).

TABLE V
Total number of scheduling chance (200 m ISD)

| | 5 | 10 | 15 | 20 | 25 |
|---|---|---|---|---|---|
| | UE/cell | UE/cell | UE/cell | UE/cell | UE/cell |
| Base AU | 118271 | 121608 | 125664 | 130183 | 136047 |
| Advanced AU | 113758 | 114677 | 114813 | 115755 | 116433 |
| Advanced AU (NRBB) | 115536 | 116671 | 118655 | 120906 | 124089 |
| Proposal 1 | 117469 | 119467 | 123110 | 127450 | 131203 |
| Proposal 2 | 114565 | 115676 | 117569 | 119324 | 121411 |
| Proposal 3 | 117274 | 119629 | 122633 | 126835 | 130541 |

Table VI below shows FDM Ratio in 200 m ISD.

TABLE VI
FDM ratio in 200 m ISD

| | 5 | 10 | 15 | 20 | 25 |
|---|---|---|---|---|---|
| | UE/cell | UE/cell | UE/cell | UE/cell | UE/cell |
| Base AU | 0.0430 | 0.0724 | 0.1081 | 0.1480 | 0.1997 |
| Advanced AU | 0.0032 | 0.0113 | 0.0125 | 0.0208 | 0.0267 |
| Advanced AU (NRBB) | 0.0188 | 0.0288 | 0.0463 | 0.0662 | 0.0943 |
| Proposal 1 | 0.0359 | 0.0535 | 0.0856 | 0.1239 | 0.1570 |
| Proposal 2 | 0.0103 | 0.0201 | 0.0368 | 0.0522 | 0.0706 |
| Proposal 3 | 0.0342 | 0.0549 | 0.0814 | 0.1185 | 0.1512 |

Table VII below shows CPE throughput in 200 m ISD.

TABLE VII
CPE throughput in 200 m ISD.

| | 5 UE/cell | | | 10 UE/cell | | |
|---|---|---|---|---|---|---|
| DL/UL | Average | 80%-tile | 5%-tile | Average | 80%-tile | 5%-tile |
| Base AU | 809.9/60.3 | 1116.9/78.5 | 310.5/26.3 | 402.9/31.2 | 496.4/38.4 | 188.6/15.6 |
| Adv. AU | 855.3/58.9 | 1116.9/78.6 | 446.8/27.5 | 427.3/29.8 | 499.2/35.6 | 248.2/16.0 |
| Prop. 1 | 855.3/59.8 | 1116.9/78.9 | 446.8/28.1 | 427.4/30.5 | 499.2/36.2 | 248.2/15.7 |
| Prop. 2 | 848.8/59.3 | 1116.9/78.9 | 424.8/27.8 | 424.0/30.0 | 499.2/35.9 | 242.9/15.8 |
| Prop. 3 | 854.0/59.6 | 1116.9/78.8 | 446.2/27.8 | 426.2/30.4 | 499.2/37.2 | 248.2/15.3 |
| | 15 UE/cell | | | 20 UE/cell | | |
| DL/UL | Average | 80%-tile | 5%-tile | Average | 80%-tile | 5%-tile |
| Base AU | 264.9/21.2 | 319.9/26.1 | 119.8/10.7 | 200.6/16.6 | 242.2/19.9 | 97.2/8.8 |
| Adv. AU | 282.7/19.7 | 340.5/24.0 | 180.4/10.4 | 211.8/14.9 | 248.2/17.9 | 139.0/8.3 |
| Prop. 1 | 282.9/20.4 | 342.0/24.9 | 179.1/10.4 | 211.8/15.7 | 248.2/19.2 | 139.1/8.3 |
| Prop. 2 | 280.4/20.1 | 327.3/24.4 | 176.7/10.5 | 209.7/15.3 | 248.2/18.5 | 130.1/8.4 |
| Prop. 3 | 282.1/20.3 | 337.1/24.7 | 181.1/9.6 | 211.6/15.6 | 248.2/19.2 | 138.2/7.6 |

| | 25 UE/cell | | |
|---|---|---|---|
| DL/UL | Average | 80%-tile | 5%-tile |
| Base AU | 158.9/13.7 | 195.8/16.5 | 70.9/7.2 |
| Adv. AU | 169.0/11.8 | 195.8/14.4 | 111.1/6.4 |
| Prop. 1 | 169.1/12.7 | 195.8/15.6 | 111.3/6.5 |
| Prop. 2 | 167.3/12.3 | 195.8/15.1 | 103.9/6.7 |
| Prop. 3 | 168.8/12.5 | 195.8/15.4 | 110.1/5.8 |

Adjacent Beam Scheduling: The UE UL throughput is increased as compared to Advanced AU.
Hybrid Beam Book Scheduling: The UE UL throughput is increased as compared to Advanced AU.
Adaptive Beam-Switching Scheduling: The UE UL throughput is increased as compared to Advanced AU, but has lower 5%-tile.

The foregoing description of the specific embodiments will so fully reveal the general nature of the embodiments herein that others can, by applying current knowledge, readily modify and/or adapt for various applications such specific embodiments without departing from the generic concept, and, therefore, such adaptations and modifications should and are intended to be comprehended within the meaning and range of equivalents of the disclosed embodiments. It is to be understood that the phraseology or terminology employed herein is for the purpose of description and not of limitation. Therefore, while the embodiments herein have been described in terms of preferred embodiments, those skilled in the art will recognize that the embodiments herein can be practiced with modification within the scope of the embodiments as described herein.

Although the present disclosure has been described with various embodiments, various changes and modifications may be suggested to one skilled in the art. It is intended that the present disclosure encompass such changes and modifications as fall within the scope of the appended claims.

What is claimed is:

1. A method performed by a network apparatus for scheduling user equipments (UEs) in a wireless communication system, the method comprising:
performing, by the network apparatus, beam sweeping using a high-resolution beam book (HRBB), wherein the beam sweeping is used for determining a beam for each UE of a plurality of UEs;
computing, by the network apparatus, a scheduling metric for each UE of the plurality of UEs;
selecting, by the network apparatus, a primary UE based on a highest scheduling metric among the plurality of UEs, wherein a beam corresponding to the primary UE is identified as a primary beam;
allocating, by the network apparatus, resources to the primary UE;
determining, by the network apparatus, whether residual bandwidth remains after allocation of the resources to the primary UE; and
scheduling, by the network apparatus, additional UEs using the residual bandwidth, wherein the additional UEs comprise UEs located within the primary beam and UEs located in beams adjacent to the primary beam, and wherein scheduling of the additional UEs utilizes spatial overlap.

2. The method of claim 1, wherein:
the HRBB comprises a plurality of beam entries, and
each beam entry of the plurality of beam entries defines at least one of a beam direction, a beam width, or a beam gain.

3. The method of claim 1, wherein:
performing beam sweeping comprises transmitting reference signals across multiple beam directions, and
received signal quality for each UE for each transmitted reference signal is measured.

4. The method of claim 1,
wherein the scheduling metric is computed based on at least one of a channel quality, a UE priority, a buffer occupancy, a UE's current data rate, a historical average throughput or a spatial overlap factor.

5. The method of claim 1,
wherein selecting the primary UE comprises ranking the plurality of UEs by the scheduling metric and choosing a UE with a highest rank.

6. The method of claim 1, wherein:
scheduling the additional UEs is performed subject to interference thresholds, and
the interference thresholds are established by the network apparatus.

7. The method of claim 1, further comprising:
identifying, by the network apparatus, a set of adjacent beams that have a spatial overlap with the primary beam, wherein UEs associated with the set of adjacent beams are aggregated into a common scheduling pool.

8. The method of claim 7, further comprising:
scheduling, by the network apparatus, uplink transmissions from the aggregated UEs in the common scheduling pool within a single frequency division multiplexing (FDM) opportunity.

9. The method of claim 1, further comprising:
dynamically combining, by the network apparatus, HRBB-based beam selection and FDM-based resource allocation.

10. The method of claim 1, wherein:
the scheduling of the additional UEs is performed in the primary beam while maintaining beamforming precision,
inter-beam interference is minimized during the scheduling, and
the method is applicable to at least one of uplink communication or downlink communication.

11. A network apparatus for scheduling UEs in a wireless communication system, comprising:
a processor;
a memory; and
an adjacent beam scheduling controller, connected to the memory and the processor, wherein the adjacent beam scheduling controller is configured to:
perform beam sweeping using a high-resolution beam book (HRBB), wherein the beam sweeping is used for determining a beam for each UE of a plurality of UEs;
compute a scheduling metric for each UE of the plurality of UEs;
select a primary UE based on a highest scheduling metric among the plurality of UEs, wherein a beam corresponding to the primary UE is identified as a primary beam;
allocate resources to the primary UE;
determine whether residual bandwidth remains after allocation of the resources to the primary UE; and
schedule additional UEs using the residual bandwidth, wherein the additional UEs comprise UEs located within the primary beam and UEs located in beams adjacent to the primary beam, and wherein the scheduling of the additional UEs utilizes a spatial overlap.

12. The network apparatus of claim 11, wherein:
the HRBB comprises a plurality of beam entries, and
each beam entry of the plurality of beam entries defines at least one of a beam direction, a beam width, or a beam gain.

13. The network apparatus of claim 11, wherein:
the adjacent beam scheduling controller is configured to transmit reference signals across multiple beam directions, and
wherein received signal quality for each UE for each transmitted reference signal is measured.

14. The network apparatus of claim 11,
wherein the scheduling metric is computed based on at least one of a channel quality, a UE priority, a buffer occupancy, a UE's current data rate, a historical average throughput or a spatial overlap factor.

15. The network apparatus of claim 11,
wherein the adjacent beam scheduling controller is configured to rank the plurality of UEs by the scheduling metric and choose a UE with a highest rank.

16. The network apparatus of claim 11, wherein:
the scheduling of the additional UEs is performed subject to interference thresholds, and
the interference thresholds are established by the network apparatus.

17. The network apparatus of claim 11, wherein:
the adjacent beam scheduling controller is configured to identify a set of adjacent beams that have a spatial overlap with the primary beam, and
UEs associated with the set of adjacent beams are aggregated into a common scheduling pool.

18. The network apparatus of claim 17,
wherein the adjacent beam scheduling controller is further configured to schedule uplink transmissions from the aggregated UEs in the common scheduling pool within a single frequency division multiplexing (FDM) opportunity.

19. The network apparatus of claim 11,
wherein the adjacent beam scheduling controller is further configured to dynamically combine HRBB-based beam selection and FDM-based resource allocation.

20. The network apparatus of claim 11, wherein:
the scheduling of the additional UEs is performed in the primary beam while maintaining beamforming precision,
inter-beam interference is decreased during the scheduling, and
the adjacent beam scheduling controller is applicable to at least one of uplink communication or downlink communication.
